(19) United States
(12) Patent Application Publication
(10) Pub. No.: US 2025/0045738 A1
(43) Pub. Date: Feb. 6, 2025

(54) BLOCKCHAIN SCRIPT ENGINE

(71) Applicant: nChain Licensing AG, Zug (CH)

(72) Inventors: Alessio PAGANI, London (GB); Chloe TARTAN, London (GB); Wei ZHANG, London (GB); Craig Steven WRIGHT, London (GB)

(21) Appl. No.: 18/717,954

(22) PCT Filed: Nov. 7, 2022
(86) PCT No.: PCT/EP2022/080932

§ 371 Date: Jun. 7, 2024

(30) Foreign Application Priority Data
Dec. 7, 2021 (GB) 2117628.4

(51) Int. Cl. G06Q 20/36

(52) U.S. Cl. CPC G06Q 20/3678; G06Q 2220/00

(57) ABSTRACT

A computer-implemented method of executing a script formed from a locking script of a first blockchain transaction and an unlocking script of a second blockchain transaction, wherein the script comprises a first script portion, a version function, and a second script portion, and wherein the method comprises: a native script engine executing the first script portion; upon encountering the version function, the native script engine terminating execution of the script and determining whether the first script portion is valid according to a blockchain protocol; in response to determining that the first script portion is valid, the native script engine supplying a sub-script comprising at least the version function and the second script portion to a versioned script engine; and the versioned script engine executing the sub-script, wherein the execution of the sub-script by the versioned script engine does not affect the validity of the first and/or second blockchain transactions.

### CROSS REFERENCE TO RELATED APPLICATIONS

This application is the U.S. National Stage of International Application No. PCT/EP2022/080932, filed on Nov. 7, 2022, which claims the benefit of United Kingdom Patent Application No. 2117628.4, filed on Dec. 7, 2021, the contents of which are incorporated herein by reference in their entireties.

### TECHNICAL FIELD

The present disclosure relates to a method of executing blockchain transactions and to a blockchain script engine configured to execute blockchain transactions.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

The blockchain is designed to allow various applications to be built upon its infrastructure. Some blockchain nodes provide not only security to the system but also additional functionalities and utilities, such as the ability to execute smart contracts. Not all nodes provide these additional functionalities, and different nodes may support different types or levels of such functionalities.

A blockchain node may signal their capability of providing additional functionality using a node protocol version number, or version number. Each version number may be associated with a particular functionality. In other words, a blockchain node may be configured to implement functionalities as part of a particular protocol. For example, the protocol may be a smart contact protocol, or a token protocol, or a particular protocol for validating transactions. As another example, the blockchain node may be configured to execute non-blockchain specific code (e.g. Python or Java) and return (i.e. output) a result of the execution of said code.

Blockchain protocols may use a scripting language for transactions. A script is essentially a list of elements, which may be data or instructions. The instructions are referred to in the literature as, script words, opcodes, commands, or functions. Opcodes (short for operation codes) perform predefined operations on the data within a script. A script may contain a version function (where function is used generally to mean a type of instruction, such as an opcode) followed by a portion of script that is only executed, or is executed in a particular way, depending on the node protocol version number associated with the blockchain node that is executing the script.

The introduction of node versioning, i.e. enabling different nodes to execute part of a script differently depending on their capabilities, can vastly increase the capabilities of nodes of the blockchain network by allowing nodes to view and validate transactions differently according to their own protocols, in addition to the native blockchain protocol. The additional functionality may range from executions of any smart contracts to validation of some specific transactions, from a game of chess to an exchange of assets, or even customised rules for validations.

However, a problem arises if the execution of a script causes one (or more) blockchain nodes to deem a transaction as valid and another blockchain node to deem a transaction as invalid. This would create a partitioning of the blockchain network, i.e. a blockchain fork. This may happen, for instance, if a blockchain node does have the capability to execute part of a script but the other does not. This may also happen if both nodes do have the capability to execute the entire script, but the nodes execute the script differently depending on their version number.

Blockchain forks are problematic from a security perspective. A fork causes some blockchain nodes to “mine on” one version of the blockchain whilst other nodes mine on a different version, e.g. one version in which a transaction is deemed valid and one version in which the same transaction is deemed invalid. Here, mining on a blockchain means attempting to add a new block to the chain. This reduces the hash rate expended on either chain. As the hash rate decreases, the potential for malicious activity increases, e.g. the so-called 51% attack whereby an entity that controls 51% of the hash rate can manipulate the blockchain. Blockchain forks are also problematic as they cause some nodes to waste resources (e.g. time, effort and processing power) on a version of the chain that will eventually lose out to the other.

It would therefore be desirable for blockchain nodes to be able to execute transactions differently, depending on their capabilities, without causing the network to partition.

According to one aspect disclosed herein, there is provided a computer-implemented method of executing a script formed from a locking script of a first blockchain transaction and an unlocking script of a second blockchain transaction, wherein the script comprises a first script portion, a version function, and a second script portion, and wherein the method comprises: a native script engine executing the first script portion; upon encountering the version function, the native script engine terminating execution of the script and determining whether the first script portion is valid according to a blockchain protocol; in response to determining that the first script portion is valid, the native script engine supplying a sub-script comprising at least the version function and the second script portion to a versioned script engine; and the versioned script engine executing the sub-script, wherein the execution of the sub-script by the versioned script engine does not affect the validity of the first and/or second blockchain transactions.

According to another aspect disclosed herein, there is provided a blockchain script engine comprising a native script engine and a versioned script engine, wherein the native script engine is configured to: execute a script comprising a first script portion, a version function, and a second script portion; upon encountering the version function, terminate execution of the script and determine whether the first script portion is valid according to a blockchain protocol; and in response to determining that the first script portion is valid, supply a sub-script comprising at least the version function and the second script portion to the versioned script engine, and wherein the version script engine is configured to execute the sub-script.

Conventionally, a blockchain node executes an entire using a native scripting engine. Now, an additional scripting engine (the versioned scripting engine) is introduced to handle versioned branches, i.e. portions of script that are executed following a version function. When the native scripting engine detects a version function, it terminates execution of the script. The validity of the executed script is checked. If the executed script is invalid, the transaction is invalidated. If the executed script is valid, the remaining part of the script is sent to the versioned scripting engine to be executed. Only the native scripting engine affects the validity of the script, and therefore the validity of the transaction. Therefore even if different nodes execute the remaining part of the script differently, all nodes will have come to the same consensus on the validity of the transaction, thus preventing forks.

Note that the version function will be referred to below as “OP_VER”. However, the disclosure is not limited to a function (e.g. opcode) having that specific label. More generally, while embodiments will be described in terms of “OP_VER” of a blockchain scripting language, the same teaching can be implemented using any function (e.g. opcode) which when called by a script engine (i.e. a script interpreter) causes the actions attributed to the version function as described herein.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 is a schematic block diagram of some node software for processing transactions,

FIG. 4 is a schematic block diagram of a system for implementing the embodiments described herein,

FIG. 5 schematically illustrates the layout of a versioned script to be executed by a dual-script engine, and

FIGS. 6 to 9 schematically illustrate example token transactions.

### DETAILED DESCRIPTION OF EMBODIMENTS

### 1. Example System Overview

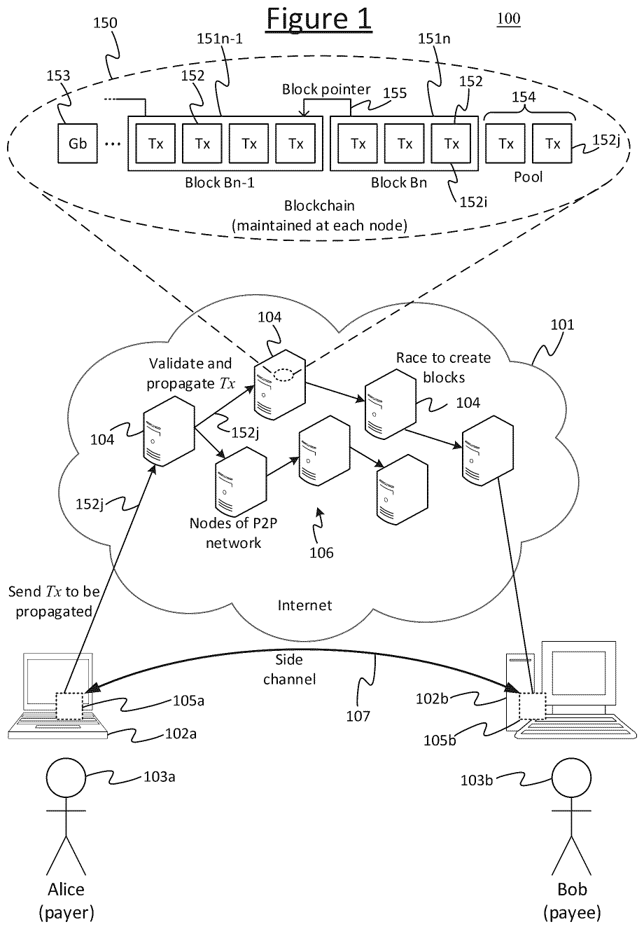

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction spends (or “assigns”), wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (or “spent”) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it spends or assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility).

The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

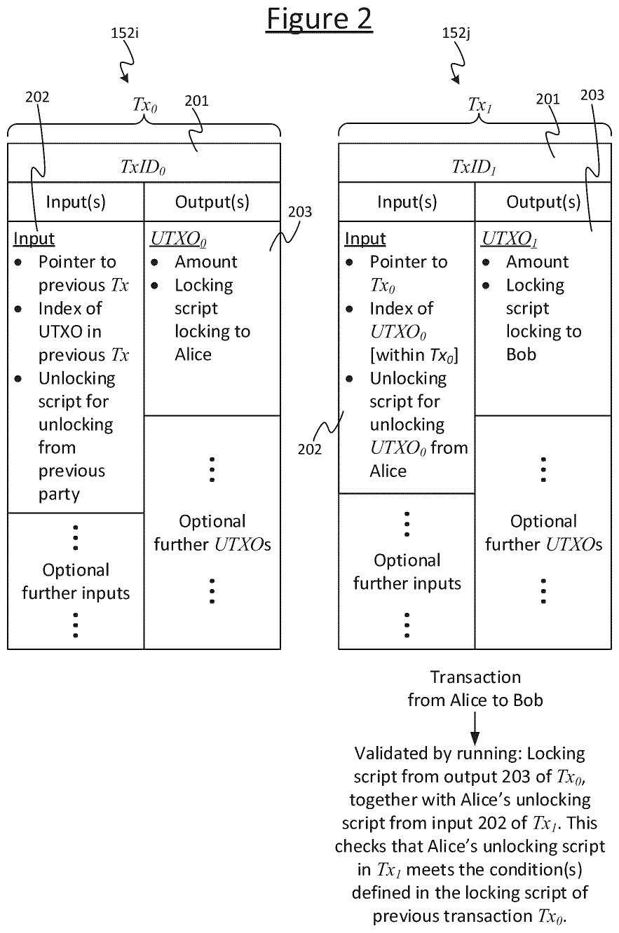

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀′ in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:
<Sig P_{A}> <P_{A}>∥[Checksig P_{A}]
   where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned (or spent) by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Node Software

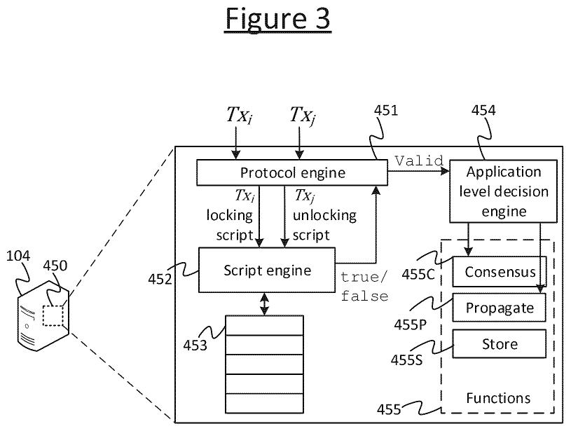

FIG. 3 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Tx and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

### 4. OP_VER

The expansion of block sizes and growth in transaction throughput has led to a huge rise in the number of blockchain-based applications within the blockchain ecosystem. Many of these emerging applications provide services beyond the basic transfer of digital assets, and thus rely on external validation or interpretation processes. While blockchain node (miner) validation relates to the validity of spending these digital assets, external validation allows businesses to create applications and services to exploit blockchain capabilities for more complex purposes. Examples of such processes include the creation of overlay networks such as the Metanet, goods and services representations such as token systems, and many more. The multitude of overlay services has encouraged block producers and blockchain enterprises to provide specialised services, resulting in the creation of de facto blockchain communities and a layered network topology.

One approach for businesses and developers to exploit layered networks involves the use of the opcode OP_VER and its related opcodes OP_VERIF, OP_VERNOTIF. These version-specific opcodes allow nodes in the network to view and validate transactions differently according to their own protocols in addition to the native Bitcoin protocol.

Using the opcode OP_VER, nodes can offer new functionality alongside transaction validation. By broadcasting their node version number, nodes effectively broadcast what services they provide to the public. This may range from the execution of any smart contracts to the validation of specific transactions such as games, exchange of assets, or even a set of customised rules for validation.

| (Function) | Opcode | Hex | When used . . . |
|---|---|---|---|
| OP_VER | 98 | 0x62 | It reads the node protocol version number from |
| | | | a local file (This file used to be serialize.h.) |
| | | | It checks and converts the value to a 4-byte |
| | | | number. |
| | | | It pushes the number to the stack. |
| OP_VERIF | 101 | 0x65 | It is equivalent to OP_VER OP_EQUAL OP_IF. |
| OP_VERNOTIF | 102 | 0x66 | It is equivalent to OP_VER OP_EQUAL |
| | | | OP_NOTIF. |

When OP_VER is enabled, block producers (i.e., miners) can choose which overlay protocol(s) they support in addition to the native blockchain protocol. More specifically, every transaction must be blockchain valid before it can be passed to the overlay protocol for validation.

A locking script using OP_VERIF can be defined as follows:

| | |
|---|---|
| Branch 1 | [P2PKH script and/or other legacy script] |
| | <0x2abc> OP_VERIF |
| Branch 2 | <additional code> |
| | OP_ENDIF |

Consider a miner, say Michelle, who supports an overlay protocol that executes custom smart contracts with node version number “0x2abc”. Michelle reflects this in her configuration file settings as “NODE_VERSION=0x2abc”. If a user, say Bob, would like to have his custom contract validated as part of a transaction, he creates a transaction that spends an outpoint with a locking script using the format proposed above.

When Michelle receives Bob's transaction, the opcode OP_VERIF detects her node version number and compares it with the version number in the locking script. Since the versions match, the custom smart contract transaction will be read and validated i.e., both Branch 1 and Branch 2 are executed. When non-participating miners receive Bob's transaction, as their node version numbers do not match, they will skip the content in the second branch and treat Bob's transaction as a standard transaction where only Branch 1 is executed.

An example logical flow that may be followed when a transaction that contains a call to OP_VER is spent may be as follows:

1. Unlocking and Locking script are concatenated.
2. Branch 1 is executed.
a. If Branch 1 is False →

| | |
|---|---|
| i. | Reject transaction. |
| ii. | End the flow. |

b. If Branch 1 is True →

| | |
|---|---|
| i. | Accept transaction. |
| ii. | Continue to Step 3. |

3. Check if node version matches the version specified by OP_VER.
a. If OP_VERIF is False →

| | |
|---|---|
| i. | End the flow. |

b. If OP_VERIF is True →

| | |
|---|---|
| i. | Continue to Step 4. |

4. Branch 2 is executed.
a. If Branch 2 is True →

| | |
|---|---|
| i. | Move the result (True) to the alt stack. Version-specific content |
| | is validated. |
| ii. | End the flow. |

b. If Branch 2 is False →

| | |
|---|---|
| i. | Move the result (False) to the alt stack. Version-specific content |
| | is rejected. |
| ii. | End the flow. |

Moving the result of the version-specific content to the alt stack (Step 4) would ensure that the transaction validation result is deterministic and independent from the node version of the miner, when all actors are honest. However, a malicious user or a computational bug may cause the result of the version-specific branch to remain on the main stack (Steps 1-3). This introduces the potential to network partitioning as OP_VER transactions may be valid for some nodes but not for others.

At the time of writing, OP_VER and its related opcodes OP_VERIF, OP_VERNOTIF are yet to be implemented. These version-specific codes enable additional features in a blockchain transaction by triggering additional checks, the results of which may be written to the ALT stack. However, should a malicious user create a transaction where the result of the version-specific branch is moved back to the main stack, then an inconsistency will emerge during the native validation process. If such a transaction is inserted in a block published by a standard (non-versioned) node, the inconsistency will translate to a partition of the network.

Consider the following script:
TRUE 0x12ab OP_VERIF FALSE OP_ENDIF

A standard node will evaluate this script as TRUE, while a version-specific node (with version number 0x12ab) would evaluate the script as FALSE. This inconsistent view on the script leads to an inconsistent view on the validity of a transaction, which further leads to a partitioning of the network. An attacker can exploit this vulnerability to create transactions with the purpose of partitioning the network, resulting in the security flaws and inefficiencies described above.

It is therefore recognised that an improved handling of the OP_VER family of opcodes is required.

### 5. Versioned Script Engine

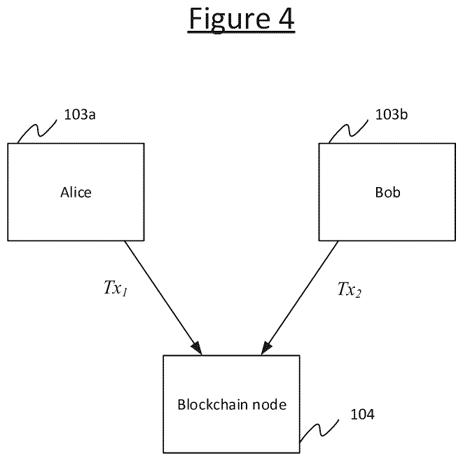

FIG. 4 illustrates an example system 400 for executing blockchain scripts according to embodiments of the present disclosure. The system 400 comprises a blockchain node 104 and one or more users, e.g. Alice 103a and Bob 103b. The blockchain node is configured to obtain a first transaction and a second transaction, e.g. from Alice 103a and Bob 103b respectively. Alternatively, the first and/or second transaction may be obtained from a different node 104, or directly from the blockchain 150.

The second transaction comprises an input that references an output of the first transaction, and thus an unlocking script of the second transaction attempts to unlock a locking script of the first transaction. To validate the second transaction, the node 104 executes the unlocking script of the second transaction alongside the locking script of the first transaction. According to some blockchain protocols, the unlocking script is executed first, followed by the locking script. Other protocols may execute the locking script first.

The blockchain node 104 has a native script engine, e.g. the script engine 452 described with reference to FIG. 3. The native script engine is used to execute transactions. More specifically, the native script engine is used to execute unlocking scripts and locking scripts of transactions. When a transaction is received, a script is formed using an unlocking script of an input of the received transaction and the locking script of a transaction output that is referenced by the input. Conventionally, the native script engine would execute the entire script, or at least attempt to execute the entire script—the execution may be terminated early if, for instance, an invalid element (e.g. function) is encountered. As another example, the execution of the script may be terminated if a return function is encountered (e.g. OP_RETURN). When the script is terminated early, the remaining script is not executed.

According to the present disclosure, the blockchain node 104 also has a versioned script engine in addition to the native script engine. The versioned script engine is configured to execute blockchain script. The difference between the native script engine and the versioned script engine is that the execution of script by the versioned script engine does not affect the validity of transactions (i.e. the transaction containing the unlocking script or the transaction containing the locking script).

The native script engine and/or versioned script engine may be implemented entirely in software, entirely in hardware, or using a combination of both software and hardware components.

When the native script engine encounters (i.e. detects) a version function, the native script engine is configured to terminate execution of the script, and determine whether the transaction is valid based on the executed script, i.e. the script that has been executed up until but not including the version function. If the transaction is valid, the native script engine sends the unexecuted script (including the version function) to the versioned script engine. The versioned script engine then executes the remaining script. The remaining script may be referred to as a “versioned script”. The versioned script engine executes script in the same was as the native script engine, except for the treatment of the version function. When the versioned script engine encounters the version function, the versioned script engine executes the version function.

If the transaction is determined to be invalid by the native script engine, the transaction is rejected and the remaining script is not sent to the versioned script engine.

By terminating execution of the script by the native script engine upon encountering the version opcode, each blockchain node 104 will have the same view of whether the transaction is valid or invalid. This is because the native script engine of each blockchain node 104 executes script in the same way, and the transaction validity is affected only by the native script engine and not the versioned script engine. Therefore the result of executing the remaining script by the versioned script engine can be different between nodes 104 without affecting the transaction validity. This enables different nodes to execute parts of a script differently (e.g. depending on their capabilities) without causing network partitioning.

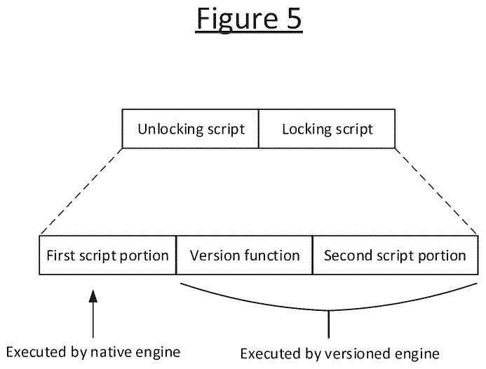

The overall script to be executed is formed from a locking script of a first transaction and an unlocking script of a second transaction (first and second are arbitrary labels). The overall script comprises a first script portion, a version function, and a second portion, in that order. In general, the version function may come from (i.e. be included as part of) the locking script of the first transaction or unlocking script of the second transaction, though the former is more likely. The native script engine only executes the first script portion, i.e. the portion of script up until the native script engine. When the version function is encountered by the native script engine, the native script engine supplies a sub-script to the versioned script engine, wherein the sub-script comprises the version function and the second script portion. This process is illustrated schematically in FIG. 5.

In some examples, the first script portion may comprise a data element representing a target version number. In these examples, the sub-script supplied to the versioned script engine also includes the target version number. The native script engine may know that the data element is the target version number, e.g. based on one or more of the format, size, type, etc. of the data element. Alternatively, the native script engine may interpret the data element adjacent to (e.g. preceding) the version number as the target version number and include this data element as part of the sub-script. Note that the target version number is provided at execution time by the native engine when creating the sub-script. That is, when the native engine creates the sub-script it adds the target version number before feeding the sub-script to the versioned engine.

In some examples, when the versioned script engine executes the version function, the versioned script engine is configured to obtain a version number of the blockchain node 104 (e.g. from memory of the node 104) and output the version number, e.g. to a stack. In general the version number may be stored in any type of memory, i.e. computer-readable storage. The version number indicates a particular protocol, i.e. functionality or capability, that the blockchain node 104 is configured to provide.

Note that the version number is not limited to being represented using integers, and may instead comprise both letters and integers. E.g. the version number may be represented in hexadecimal.

In some examples, the blockchain node 104 may output a fixed-length representation of the version number instead of the version that is obtained from memory. E.g. the stored version number may be of a larger length (e.g. six bytes) but only the first four bytes are output.

The versioned script engine may compare the obtained version number with the target version number supplied by the native script engine as part of the sub-script. The execution of the sub-script (specifically the second script portion) may be dependent on whether or not the obtained version number and the target version number match. For example, the second script portion may only be executed if the version numbers match. Alternatively, the second script may only be executed if the version numbers do not match.

In some examples, the second script portion may itself contain one or more version functions, each associated with a respective script portion (i.e. a respective section of the second script portion) and a respective target version number. The versioned script engine may be configured to execute each respective script portion based on the associated respective target version number. For example, the respective script portions may only be executed if the respective target version number matches the version number associated with the blockchain node 104. Alternatively, the respective script portions may only be executed if the respective target version number does not match the version number associated with the blockchain node 104. It may also be the case that some respective portions are executed (e.g. because of matching version numbers) and some respective script portions are not executed (e.g. because of non-matching version numbers), or vice versa.

The blockchain node 104 may be configured to output the result of executing the second script portion and/or the respective results of executing the respective script portions of the second script portion, e.g. to memory, to the stack, to one or more users 103a, 103b, or to the blockchain. For example, the result(s) may be included in an output (e.g. an OP_RETURN output) of a blockchain transaction.

In some examples, the blockchain node 104 may obtain a plurality of results, each the result of executing a respective versioned script. The blockchain node 104 may construct a Merkle tree using the results as respective leaves of the Merkle tree, and store the root of the Merkle tree on the blockchain, e.g. as part of an OP_RETURN output. The versioned scripts may be related in some way, e.g. they may relate to the same layer-2 protocol or application, such as a token protocol.

In general, the versioned script may comprise any type of script or code. For example, the versioned script may comprise a portion of script written in the native blockchain scripting language, e.g. Script. In other words, the portion of code may comprise data and/or opcodes of the native scripting language which any blockchain node is configured to execute. For example, the portion of code may comprise a blockchain address and a script for requiring an unlocking script to include a corresponding public key and signature, as is the case for pay-to-public-key-hash (P2PKH) outputs.

In other examples, the versioned script may comprise a portion of script written in a non-native scripting language, i.e. a scripting language native to a different blockchain. For example, the native scripting language may be native to the Bitcoin blockchain, whilst the non-native scripting language may be native to the Ethereum blockchain.

In some examples, the versioned script may comprise code written in a non-blockchain language, i.e. a language that is not specific to any blockchain. For example, the portion of code may be written using a programming language such as C, C++, Go, Ruby, Python, Java, JavaScript, etc.

### 6. Versioned Script Engine & OP_VER

This section provides further example of the described embodiments in the context of the version function being one of the family of OP_VER opcodes. It should be appreciated that OP_VER is just one example of a version function that may be used to trigger the termination of script execution by the native script engine and the triggering of script executing by a versioned script engine.

The use of the versioned script engine as part of a dual-verification script engine prevents network partitioning without imposing major limitations on the implementation and usage of the family of OP_VER codes. The dual-verification script engine requires that these version-specific opcodes use an independent validation engine, herein referred to as the versioned engine, which is the default validation engine for versioned branches in scripts and facilitates version specific overlay validation. The term native engine refers to the native validation engine. During the validation of a blockchain transaction, the opcodes are sequentially executed by the native engine. Once the first OP_VER or related opcode is encountered, the native engine is terminated, and the validity of this execution is checked by the native engine. If the native execution is deemed to be valid, then the versioned engine is instantiated (otherwise the entire process terminates, and the transaction is rejected).

The versioned engine does not determine or affect whether a transaction is valid according to the blockchain protocol. The execution result from a versioned engine will be interpretated independently from the native blockchain protocol and can be application specific.

The versioned engine may follow the same script rules as the native engine except for OP_VER and its related opcodes. This ensures that any versioned branches can be replayed in the future. As an alternative, the versioned engine may run any code that is specified by the node version number. This approach offers great flexibility.

In summary, this dual engine approach to OP_VER offers a consistent view on validity of transactions by separating versioned branches from a standard branch in a script. Moreover, it does not require additional memory as the versioned engine will only be instantiated after the native engine is terminated.

While the common native validation process allows a transaction to be published on-chain without the risk of partitioning the network, the version-specific validation process can be used to create communities of application-specific nodes. Namely, all nodes validate transactions according to the native protocol, while only a subset of nodes validate specific applications and services that are specified by their node version number e.g., tokens, smart contracts, or snippets.

Since OP_VER, OP_VERIF and OP_VERNOTIF are always executed in the versioned engine, the native engine must perform some specific steps upon encountering one of these opcodes. We refer to this as the dual engine validation (DEV) rules.

The native validation process for versioning-related opcodes is as follows:

### Native Validation Process for OP_VER:

1. When encountering the first OP_VER, terminate the native engine.
2. Check the execution validity.
   a. if invalid, reject transaction and abort.
3. Create a subscript, which includes everything that was part of the initial script starting from the first OP_VER. That is, the subscript includes all the opcodes not yet processed by the native engine.
4. Instantiate the versioned engine.
5. Feed the newly created subscript to the versioned engine.

### Native Validation Process for OP_VERIF & OP_VERNOTIF:

1. Consume and store the top element on the stack as V (this would be a version number).
2. Terminate the native engine.
3. Check native execution validity.
   a. If invalid, reject transaction and abort.
4. Create a subscript, which includes everything that was part of the initial script starting from the first OP_VERIF or OP_VERNOTIF. Prepend to the subscript the version number V. The resulting subscript starts with V OP_VERIF (or OP_VERNOTIF).
5. Instantiate the versioned engine.
6. Feed the newly created subscript to the versioned engine.

All the remaining versioning-related opcodes included in the subscript are then executed in the versioned engine.

The behaviour of the versioning-related opcodes in the versioned engine is as follows:

### Versioned Validation Process for OP_VER:

1. Read the node version number from a local configuration file.
2. Format the number in 4 bytes.
3. Push the number to the stack.

### Versioned Validation Process for OP_VERIF & OP_VERNOTIF:

1. OP_VERIF is equivalent to OP_VER OP_EQUAL OP_IF
2. OP_VERNOTIF is equivalent to OP_VER OP_EQUAL OP_NOTIF

From a logical viewpoint, <0x2abc> OP_VERIF is equivalent to OP_VER <0x2abc> OP_EQUAL OP_IF. However, from an execution viewpoint, there is a difference when they are executed in the native engine that is worth mentioning: OP_VERIF consumes one element from the main stack, while OP_VER does not.

Following the above logic, standard and versioned branches of code in the locking script can be included in the same script, e.g. as shown below.

| | |
|---|---|
| Standard: | [P2PKH script and/or other legacy script] |
| Branch | |
| Versioned: | OP_VER |
| Branch 1 | <additional code> |
| Versioned: | <0x4def> OP_VERIF |
| Branch 2 | <additional code> |
| | OP_ENDIF |
| . . . | OP_VER |
| | ... |
| Versioned: | <0x...> OP_VERIF |
| Branch n | ... |
| | OP_ENDIF |

Depending on the particular blockchain protocol, the standard branch may be required to appear before any versioning opcodes in order to have a valid transaction.

Note that the behaviour of any opcodes that immediately terminate a script (e.g., OP_RETURN) remains unchanged, such that they terminate the entire script in both native and versioned engines.

While each node is assigned at most one version number, a single version number may provide access to more than one branch of versioned code. Let us consider the following locking script:
OP_VER 0x1 OP_EQUAL OP_IF< . . . >
OP_VER 0x2 OP_EQUAL OP_NOTIF < . . . >

Here, the use of different conditional statements means that both branches are executed by the node with version number 0x1.

Two examples of the DEV process from the perspective of a node with version number 0x1 are now described. In the first example, OP_VER is used to sum 1 to a predefined number in the versioned engine while, in the second example, OP_VERIF is used to achieve the same result.

### Example Using OP_VER:

The locking script is:
OP_DUP OP_HASH160<PubKeyHash> OP_EQUALVERIFY OP_CHECKSIG OP_VER 0x1 OP_EQUAL OP_IF OP_5 OP_1ADD OP_ENDIF

The unlocking script is:
<Sig><PubKey>

The concatenation of the unlocking and locking scripts gives the script to be validated as: <Sig><PubKey>OP_DUP OP_HASH160<PubKeyHash>OP_EQUALVERIFY OP_CHECKSIG OP_VER 0x1 OP_EQUAL OP_IF OP_5 OP_1ADD OP_ENDIF

At the end of the Standard branch, the top of the native engine main stack contains the result of the signature check (e.g., True):

| Native Engine MAIN STACK | Versioned Engine MAIN STACK |
|---|---|
| True | Uninstantiated |

As OP_VER is encountered, the native engine is terminated. A subscript is created as the following:
OP_VER 0x1 OP_EQUAL OP_IF OP_5 OP_1ADD OP_ENDIF

The versioned engine is instantiated to execute the subscript.

| | |
|---|---|
| Native Engine MAIN STACK | Versioned Engine MAIN STACK |

True

The subscript execution begins with OP_VER which pushes the version number of the node (say 0x1) in the versioned engine:

| Native Engine MAIN STACK | Versioned Engine MAIN STACK |
|---|---|
| True | 0x1 (pushed by OP_VER) |

The remaining subscript to be validated is:
0x1 OP_EQUAL OP_IF OP_5 OP_1ADD OP_ENDIF

Now, 0x1 is pushed to the versioned main stack:

| Native Engine MAIN STACK | Versioned Engine MAIN STACK |
|---|---|
| | 0x1 |
| True | 0x1 (pushed by OP_VER) |

Remaining subscript:
OP_EQUAL OP_IF OP_5 OP_1ADD OP_ENDIF

The OP_EQUAL opcode is executed, and the result is written to the stack:

| Native Engine MAIN STACK | Versioned Engine MAIN STACK |
|---|---|
| True | True |

Remaining script:
OP_IF OP_5 OP_1ADD OP_ENDIF

The remaining opcodes are executed: OP_IF consumes the top element in the versioned stack, the remaining opcodes are consumed and the result is written to the versioned stack:

| Native Engine MAIN STACK | Versioned Engine MAIN STACK |
|---|---|
| True | 6 |

The script validation results for all nodes in the network are as follows:
Nodes with version number==0x1
   Standard: True (transaction published on-chain)
   Versioned: 6
Nodes with version number !=0x1
   Standard: True (transaction published on-chain)
   Versioned: Empty

### Example Using OP_VERIF:

Locking script:
OP_DUP OP_HASH160<PubKeyHash>OP_EQUALVERIFY OP_CHECKSIG 0x1 OP_VERIF OP_5 OP_1ADD OP_ENDIF

The unlocking script is:
<Sig><PubKey>

Thus, the script to be validated is:
<Sig><PubKey>OP_DUP OP_HASH160<PubKeyHash>OP_EQUALVERIFY OP_CHECKSIG 0x1 OP_VERIF OP_5 OP_1ADD OP_ENDIF

At the end of the standard branch, the top of the main stack contains the result of the signature check (e.g., True) and then 0x1 is pushed to the stack. The status of both engine main stacks is:

| Native Engine MAIN STACK | Versioned Engine MAIN STACK |
|---|---|
| 0x1 | |
| True | Uninstantiated |

When OP_VERIF is encountered, the top element on the main stack is consumed and stored. Then the native engine is terminated. As the execution is valid, a subscript is created as the following:
0x1 OP_VERIF OP_5 OP_1ADD OP_ENDIF

The versioned engine is instantiated to execute the subscript.

| | |
|---|---|
| Native Engine MAIN STACK | Versioned Engine MAIN STACK |

True

0x1 is pushed to the versioned engine main stack

| Native Engine MAIN STACK | Versioned Engine MAIN STACK |
|---|---|
| True | 0x1 |

OP_VERIF is executed as OP_VER OP_EQUAL OP_IF and the execution continues to OP_5 OP_1 OP_ADD.

| Native Engine MAIN STACK | Versioned Engine MAIN STACK |
|---|---|
| True | 6 |

The script validation results are as follows:
Nodes with version number==0x1:
   Standard: True (transaction published on-chain)
   Versioned: 6
Nodes with version number !=0x1:
   Standard: True (transaction published on-chain)
   Versioned: Empty

The dual validation described in the above examples may be generalised as follows. When validating a transaction containing versioning-related opcodes, the following logical flow is followed:
1. Unlocking and Locking scripts are concatenated.
2. Standard Branch is executed and the native engine is terminated.
   a. If Standard Branch results False, reject the transaction and end the flow.
   b. If Standard Branch results True, accept the transaction and continue to Step 3.
3. Create a subscript following the rules described above.
4. Instantiate the versioned engine.
5. Execute the subscript.

The usage and functionality of the OP_VER family may be extended to facilitate scripts containing multiple version numbers. For example,

| | |
|---|---|
| Standard: | [P2PKH script or other script executed by all nodes] |
| Branch 1 | |
| Versioned: | OP_VER |
| Branch 1 | <additional code executed by all nodes> |
| | OP_VER <0x2abc> OP_EQUAL OP_IF |
| Versioned: | <additional code executed by node 0x2abc only> |
| Branch 2 | OP_ENDIF |
| Versioned: | OP_VER <0x3cde> OP_EQUAL OP_NOTIF |
| Branch 3 | <additional code executed by all nodes excluding |
| | node 0x3cde> |
| | OP_ENDIF |
| | <0x4efg> OP_VERIF |
| Versioned: | <additional code executed by node 0x4efg only> |
| Branch 4 | OP_ENDIF |

The validation result from the native engine determines whether a transaction can be published in a block, while the validation results from the versioned engine would have no impact on the publication of the transaction. However, if the validation result from the versioned engine is recorded, then the transaction must be valid, because the versioned engine can only be instantiated if the native validation gives TRUE. Therefore, for any off-chain record of a versioned validation result, one may identify a published transaction and replay the execution of the scripts to obtain the same result. This capability of replaying scripts at any given time in the future makes OP_VER-based applications and services more transparent and auditable, and hence more trustworthy.

For more convenience, the record of versioned validation results (i.e. the result of executing script following OP_VER) may be published in a transaction as an OP_RETURN payload or consolidated in a Merkle tree whose Merkle root can be published in a Bitcoin transaction. This can be done by nodes 104, application or service providers, or a dedicated third party. They would not cheat on the results as all results can be obtained publicly by replaying the execution of relevant scripts. For example, in an OP_VER-based token system, the token issuer may gather all token transactions that are at least 6 blocks deep, derive a system state such as the allocation of tokens in circulation from the versioned validation results, and publish the system state in a transaction that is signed by the issuer themselves.

The following describes a use case in which token transactions are implemented using a token specific version number. A commensal token chain pegs the token value to bitcoin and uses a versioned branch to validate the token rules. Each token chain has a dedicated node version number, and each token transaction represents only one type of token.

In this section, we describe how to merge tokens from different token chains in one transaction and how to split them subsequently. We assume that there is a token platform from which all token issuers issue and manage their tokens using the commensal token chain. Tokens can be traded as financial instruments on this platform. To simplify the exchange of transactions, the base currency for trading tokens is assumed to be fiat and is settled independently to the blockchain (in the case that the base currency is bitcoin, an additional input-output pair would be required to denote the token transaction in the Bitcoin platform). It is assumed that there is a trusted oracle who signs off token transactions to make them Bitcoin-valid after checking that they are token-valid. The oracle is trusted in the sense that it guarantees the provision of a signature on valid token transactions and will not burn tokens by creating valid transactions that are token-invalid. The detail will be explained in the example transactions below.

Let Alice be a token issuer. Alice can partner with a Bitcoin node, say Natalie, who sets their node version number to be 0xaaaa to represent Alice's token. Let Bob be another token issuer who partners with a different Bitcoin node, say Musha, who sets their node version number to be 0xbbbb to represent Bob's tokens.

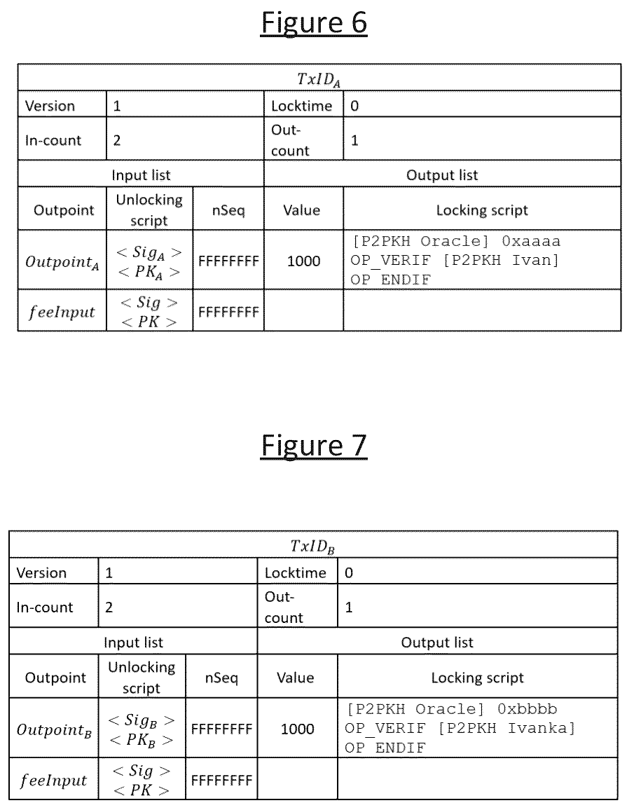

Starting with Alice's token, Alice creates a token issuance transaction to issue 1000 units of her tokens to an investor, Ivan. This can be viewed as an initial token offering (ITO). Alice's transaction is shown in FIG. 6. Note that the token value is pegged to the number of satoshis in the Bitcoin transaction, whereby one token unit is equal to one satoshi. The token transfer is captured in the versioned branch, while the standard branch creates a valid Bitcoin transaction to carry the token transfer. Similarly, Bob issues 1000 of his token units to another investor, Ivanka. Bob's transaction is shown in FIG. 7.

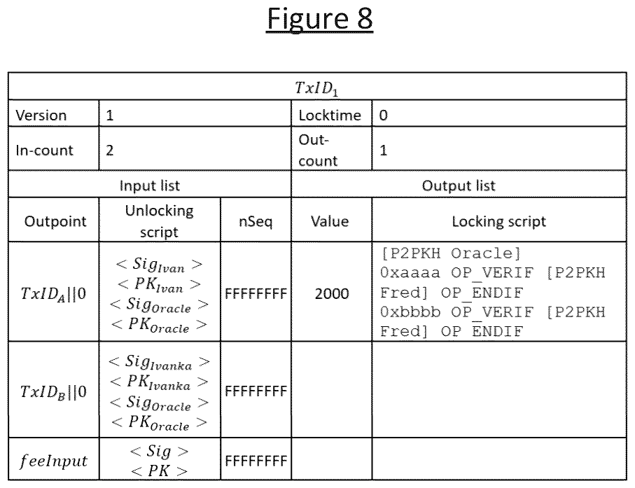

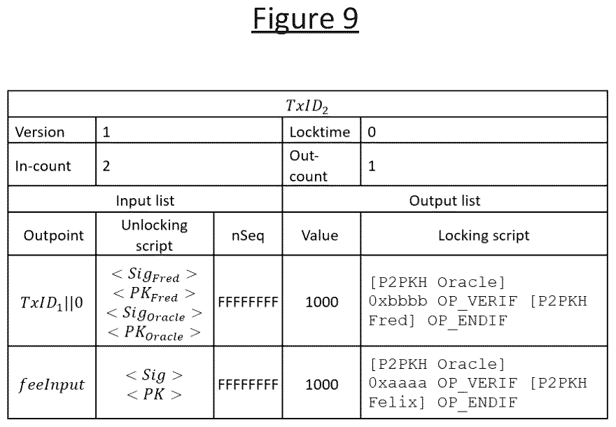

Now, assume that Fred is a fund manager who is interested in both Alice's and Bob's tokens. He purchases 1000 units of both tokens from Ivan and Ivanka, respectively. The transfer of these tokens can be captured in a single transaction as shown in FIG. 8. Here, Fred's token portfolio is captured by one output of a transaction that combines the transfer of different types of tokens. After some appreciation of Alice's token, Fred decides to sell them to Felix, using the transaction shown in FIG. 9.

Note that we do not need two copies of Fred's digital signature as no node 104 would validate both versioned branches in the output of TxID₁. At this point, the state of Alice's token chain is maintained by Natalie based on TxID_{A}, TxID₁ and TxID₂, while the state of Bob's token chain is maintained by Musha based on TxID_{B}, TxID₁ and TxID₂.

An adversary, who can intercept transactions before they are published, may change the unlocking script in the input of a token transaction in such a way that the transaction becomes token-invalid, while still being Bitcoin-valid. For example, the adversary can change or remove the signatures in the unlocking script that would be verified by a versioned branch, i.e., <Sig_{Fred}><PK_{Fred}> in TxID₂. This type of attack effectively denies or disrupts token services. One way to mitigate such attacks is for the oracle to send transactions to versioned nodes via mAPI, a secure communication channel between Bitcoin nodes and users. After receiving the token transactions, the node 104 only propagates token transactions after a valid block header for the block that contains those token transactions has been found.

This use case demonstrates that it is advantageous to have multiple version numbers in one output. The advantage is that each user of the token platform only needs to manage one transaction output at any time, regardless of how many types of tokens they are holding.

### 7. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Statement 1. A computer-implemented method of executing a script formed from a locking script of a first blockchain transaction and an unlocking script of a second blockchain transaction, wherein the script comprises a first script portion, a version function, and a second script portion, and wherein the method is performed by a blockchain node and comprises:
a native script engine executing the first script portion;
upon encountering the version function, the native script engine terminating execution of the script and determining whether the first script portion is valid according to a blockchain protocol;
in response to determining that the first script portion is valid, the native script engine supplying a sub-script comprising at least the version function and the second script portion to a versioned script engine; and
the versioned script engine executing the sub-script, wherein the execution of the sub-script by the versioned script engine does not affect the validity of the first and/or second blockchain transactions.

Statement 2. The method of statement 1, wherein the first script portion comprises a target node protocol version number, and wherein the sub-script comprises the target node protocol version number.

Statement 3. The method of statement 1 or statement 2, wherein said executing of the sub-script comprises executing the version function, and wherein said executing of the version function comprises:
obtaining a node protocol version number of the blockchain node; and
outputting the node protocol version number, wherein the node protocol version number is associated with a particular functionality that the blockchain node is configured to execute.

Statement 4. The method of statement 2 and statement 3, wherein said executing of the version function comprises determining whether the output node protocol version number matches the target node protocol version number.

Statement 5. The method of statement 4, wherein said executing of the version function comprises:
if the output node protocol version number does match the target node protocol version number, executing the second script portion, and
if the output node protocol version number does not match the target node protocol version number, not executing the second script portion.

Statement 6. The method of statement 4, wherein said executing of the version function comprises:
if the output node protocol version number does match the target node protocol version number, not executing the second script portion, and
if the output node protocol version number does not match the target node protocol version number, executing the second script portion.

Statement 7. The method of any preceding statement, wherein the second script portion comprises a plurality of respective version functions, each respective version function being associated with a respective script portion.

Statement 8. The method of statement 7, wherein each respective script portion is associated with a respective target node protocol version number, and wherein the method comprises:
the versioned script engine executing the respective script portion based on the node protocol version number.

Statement 9. The method of any preceding statement, comprising outputting a result of said execution of the sub-script to a user.

Statement 10. The method of any preceding statement, comprising:
storing a result of said execution of the sub-script on the blockchain.

Statement 11. The method of any preceding statement, comprising:
obtaining a plurality of respective results, each respective result obtained from the execution of a respective script formed from a respective locking script of a respective first blockchain transaction and a respective unlocking script of a respective second blockchain transaction, wherein the respective script comprises a respective first script portion, a respective version function, and a respective second script portion;
generating a Merkle tree based on the plurality of respective results; and
storing a Merkle root of the Merkle tree on the blockchain.

Statement 12. The method of statement 3 or any statement dependent thereon, wherein said outputting of the node protocol version number comprises outputting a fixed-length representation of the node protocol version number.

Statement 13. The method of any preceding statement, wherein the second script portion comprises a portion of code written in a language other than a native blockchain language, and wherein the blockchain node is configured to execute code written in that language.

Statement 14. The method of statement 13, wherein the portion of code is written in a blockchain language other than the native blockchain language.

Statement 15. The method of any of statements 1 to 12, wherein the second script portion comprises a locking condition based on a public key and/or a public key hash.

Statement 16. The method of any preceding statement, wherein the first and second transactions are respective token transactions, and wherein the target node protocol version number is associated with a token protocol.

Statement 17. The method of any preceding statement, wherein the version function is one of the following opcodes: OP_VER, OP_VERIF or OP_VERIFNOT.

Statement 18. Computer equipment comprising:
memory comprising one or more memory units; and
processing apparatus comprising one or more processing units, wherein the memory stores code arranged to run on the processing apparatus, the code being configured so as when on the processing apparatus to perform the method of any preceding statement.

Statement 19. A computer program embodied on computer-readable storage and configured so as, when run on one or more processors, to perform the method of any of statements 1 to 17.

Statement 20. A blockchain script engine comprising a native script engine and a versioned script engine, wherein the native script engine is configured to:
execute a script comprising a first script portion, a version function, and a second script portion;
upon encountering the version function, terminate execution of the script and determine whether the first script portion is valid according to a blockchain protocol; and
in response to determining that the first script portion is valid, supply a sub-script comprising at least the version function and the second script portion to the versioned script engine, and
wherein the version script engine is configured to execute the sub-script.

1. A computer-implemented method of executing a script formed from a locking script of a first blockchain transaction and an unlocking script of a second blockchain transaction, wherein the script comprises a first script portion, a version function, and a second script portion, and wherein the method is performed by a blockchain node and comprises:
executing, by a native script engine of the blockchain node, the first script portion;
upon encountering the version function, the native script engine terminating execution of the script and determining whether the first script portion is valid according to a blockchain protocol;
in response to determining that the first script portion is valid, the native script engine supplying a sub-script comprising at least the version function and the second script portion to a versioned script engine of the blockchain node; and
executing, by the versioned script engine, the sub-script, wherein the execution of the sub-script by the versioned script engine does not affect the validity of either of the first and the second blockchain transactions.

2. The method of claim 1, wherein the first script portion comprises a target node protocol version number, and wherein the sub-script comprises the target node protocol version number.

3. The method of claim 1, wherein said executing of the sub-script comprises executing the version function, and wherein said executing of the version function comprises:
obtaining a node protocol version number of the blockchain node; and
outputting the node protocol version number, wherein the node protocol version number is associated with a particular functionality that the blockchain node is configured to execute.

4. The method of claim 2, wherein said executing of the sub-script comprises executing the version function, wherein said executing of the version function comprises:
obtaining a node protocol version number of the blockchain node; and
outputting the node protocol version number, wherein the node protocol version number is associated with a particular functionality that the blockchain node is configured to execute;
wherein said executing of the version function comprises determining whether the output node protocol version number matches the target node protocol version number.

5. The method of claim 4, wherein said executing of the version function comprises:
if the output node protocol version number does match the target node protocol version number, executing the second script portion, and
if the output node protocol version number does not match the target node protocol version number, not executing the second script portion.

6. The method of claim 4, wherein said executing of the version function comprises:
if the output node protocol version number does match the target node protocol version number, not executing the second script portion, and
if the output node protocol version number does not match the target node protocol version number, executing the second script portion.

7. The method of claim 1, wherein the second script portion comprises a plurality of respective version functions, each respective version function being associated with a respective script portion.

8. The method of claim 7, wherein each respective script portion is associated with a respective target node protocol version number, and wherein the method comprises executing, by the versioned script engine, the respective script portion based on the node protocol version number.

9. The method of claim 1, further comprising outputting, by the blockchain node, a result of said execution of the sub-script to a user.

10. The method of claim 1, further comprising storing a result of said execution of the sub-script on the blockchain.

11. The method of claim 1, further comprising:
obtaining, by the blockchain node, a plurality of respective results, each respective result obtained from the execution of a respective script formed from a respective locking script of a respective first blockchain transaction and a respective unlocking script of a respective second blockchain transaction, wherein the respective script comprises a respective first script portion, a respective version function, and a respective second script portion;
generating, by the blockchain node, a Merkle tree based on the plurality of respective results; and
storing, by the blockchain node, a Merkle root of the Merkle tree on the blockchain.

12. The method of claim 3, wherein said outputting of the node protocol version number comprises outputting a fixed-length representation of the node protocol version number.

13. The method of claim 1, wherein the second script portion comprises a portion of code written in a language other than a native blockchain language, and wherein the blockchain node is configured to execute code written in the language.

14. The method of claim 13, wherein the portion of code is written in a blockchain language other than the native blockchain language.

15. The method of claim 1, wherein the second script portion comprises a locking condition based on a public key and/or a public key hash.

16. The method of claim 1, wherein the first and second transactions are respective token transactions, and wherein the target node protocol version number is associated with a token protocol.

17. The method of claim 1, wherein the version function is one of the following opcodes: OP_VER, OP_VERIF or OP_VERIFNOT.

18. Computer equipment, comprising:
memory comprising one or more memory units; and
processing apparatus comprising one or more processing units, wherein the memory stores code arranged to run on the processing apparatus, the code being configured so as when run on the processing apparatus, the processing apparatus performs a method of executing a script formed from a locking script of a first blockchain transaction and an unlocking script of a second blockchain transaction, wherein the script comprises a first script portion, a version function, and a second script portion, and wherein the method comprises:
executing the first script portion;
upon encountering the version function, terminating execution of the script and determining whether the first script portion is valid according to a blockchain protocol; and
in response to determining that the first script portion is valid, executing a sub-script comprising at least the version function and the second script portion, wherein the execution of the sub-script does not affect the validity of either of the first and the second blockchain transactions.

19. A computer program embodied on computer-readable storage and configured so as, when run on one or more processors, to perform a method of executing a script formed from a locking script of a first blockchain transaction and an unlocking script of a second blockchain transaction, wherein the script comprises a first script portion, a version function, and a second script portion, and wherein the method comprises:
executing the first script portion;
upon encountering the version function, terminating execution of the script and determining whether the first script portion is valid according to a blockchain protocol; and
in response to determining that the first script portion is valid, executing a sub-script comprising at least the version function and the second script portion, wherein the execution of the sub-script does not affect the validity of either of the first and the second blockchain transactions.

20. (canceled)
